(19) United States
(12) Patent Application Publication
(10) Pub. No.: US 2024/0020921 A1
(43) Pub. Date: Jan. 18, 2024

(54) INFORMATION SHARING PROGRAM AND INFORMATION PROCESSING APPARATUS

(71) Applicant: MUJURYOKU INC., Tokyo (JP)

(72) Inventor: Takayuki ROKUTAN, Tokyo (JP)

(21) Appl. No.: 18/446,475

(22) Filed: Aug. 9, 2023

Related U.S. Application Data
(63) Continuation of application No. PCT/JP2021/031275, filed on Aug. 26, 2021.

(30) Foreign Application Priority Data
Feb. 10, 2021 (JP) 2021-019663

(51) Int. Cl. G06T 17/00; G06F 16/958

(52) U.S. Cl. CPC G06T 17/00; G06F 16/958

(57) ABSTRACT

To provide an information sharing program and an information processing apparatus in which transmission of real information itself of a virtual object between terminals is not required and preparation for virtual data reproduction in a reproduction terminal is not required when the virtual object is shared. An information processing apparatus includes: a virtual object receiving means that receives virtual object information, which is generated in terminals (2a), (2b) . . . by imaging objects (a), (b) . . . as subjects, and stores the virtual object information in a storage; a web page generating means that generates web page information capable of reproducing the virtual object information on a web page; and an information output means that transmits to terminals (3a), (3b) . . . which are sharing destinations an information on an access to the web page information, upon receiving the requests for sharing and the information on the sharing destinations of the terminals (2a), (2b) . . .

### RELATED APPLICATIONS

The present application is a bypass continuation application of PCT Application No. PCT/JP2021/031275 filed Aug. 26, 2021, which is based on and claims the benefit of priority from the prior Japanese patent application 2021-019663 filed on Feb. 10, 2021. The entire contents of the above-captioned applications are incorporated herein by reference.

### TECHNICAL FIELD

Embodiments relate to an information sharing program and an information processing apparatus.

### BACKGROUND ART

As a conventional technique, an information sharing program for sharing AR (Augmented Reality) data between terminals has been proposed (for example, see Patent Literature 1).

When the information sharing program disclosed in

Patent Literature 1 transmits video images from a remote terminal to a user terminal, transmits object recognition information for recognizing an object included in the video images, and receives the video images and the object recognition information on the user terminal, the information sharing program recognizes the object in the video images, generates AR result information as a recognition result, and displays the AR result information and the object.

### CITATION LIST

### Patent Literature

Patent Literature 1: JP 2012-043435 A

### SUMMARY OF INVENTION

### Technical Problem

However, there is a problem in that since the information sharing program needs to recognize the object to generate the AR result information in the user terminal, a program for generation needs to be installed in the user terminal in advance and preparation is required in the user terminal in advance.

The object of the embodiments is to provide an information sharing program and an information processing apparatus in which transmission of real information itself of a virtual object between terminals is not required and preparatory processes for virtual data reproduction in a reproduction terminal are reduced when the virtual object is shared.

### Solution to Problem

In order to achieve the above-described object, aspects of the embodiments provide the following information sharing program and information processing apparatus.

Aspects of a first embodiment include an information sharing program for causing a computer to function as: a receiving means that receives and stores virtual object information generated in a terminal by imaging a subject; a generating means that generates web page information capable of reproducing the virtual object information on a web page; and an information output means that transmits to a sharing destination information on an access to the web page information, on receiving a sharing request and information on the sharing destination of the terminal.

Aspects of a second embodiment include the information sharing program according to the first embodiment, wherein the generating means generates web page information for reproducing one or a plurality of pieces of virtual object information generated by imaging the subject on a web page based on an accompanying information of the virtual object.

Aspects of a third embodiment include the information sharing program according to the first or the second embodiment, further causing the computer to function as an output means that extracts, as a change information, information related to at least one of a size and a weight of the subject from a plurality of pieces of virtual object information generated by imaging the subject, and outputs the change information.

Aspects of a fourth embodiment include the information sharing program according to the first or the second embodiment, further causing the computer to function as an output means that extracts, as a change information, information related to at least one of a size and a weight from a plurality of pieces of virtual object information generated by imaging the subject, and outputs a notification when based on the change information, the size matches, exceeds, or falls below a predetermined size or is expected to match, exceed, or fall below the predetermined size.

Aspects of a fifth embodiment include the information sharing program according to any one of the first to the fourth embodiment, wherein the generating means generates a web page for reproducing a taken image on a terminal that displays the web page together with the virtual object.

Aspects of a sixth embodiment include an information processing apparatus including: a receiving means that receives and stores virtual object information generated in a terminal by imaging a subject; a generating means that generates web page information capable of reproducing the virtual object information on a web page; and an information output means that transmits to a sharing destination an information on an access to the web page information, on receiving a sharing request and an information on the sharing destination of the terminal.

### Advantageous Effects of Invention

According to the first or the sixth embodiment, it is possible that transmission of real information itself of a virtual object between terminals is not required and preparation for virtual data reproduction in a reproduction terminal is not required when the virtual object is shared.

According to the second embodiment, it is possible to reproduce one or a plurality of pieces of virtual object information generated by imaging the subject on a web page based on an accompanying information of the virtual object.

According to the third embodiment, it is possible to cause a computer to further function as an output means that extracts, as a change information, an information related to at least one of a size and a weight of the subject from a plurality of pieces of virtual object information generated by imaging the subject, and outputs the change information.

According to the fourth embodiment, it is possible to extract, as a change information, an information related to at least one of a size and a weight from a plurality of pieces of virtual object information generated by imaging the subject, and output a notification when based on the change information, the size matches, exceeds, or falls below a predetermined size or is expected to match, exceed, or fall below the predetermined size.

According to the fifth embodiment, it is possible to generate a web page for reproducing a taken image on a terminal that displays the web page together with a virtual object.

### BRIEF DESCRIPTION OF DRAWINGS

FIG. 1 is a schematic diagram illustrating an example of a configuration of an information processing system according to an embodiment.

FIG. 2 is a block diagram illustrating a configuration example of an information processing apparatus according to the embodiment.

FIG. 3 is a schematic diagram illustrating a configuration example of user information.

FIG. 4 is a schematic diagram illustrating a configuration example of virtual object information.

FIG. 5 is a schematic diagram illustrating a configuration example of change information.

FIG. 6 is a schematic diagram illustrating a configuration example of notification setting value information.

FIG. 7 is a schematic diagram for explaining one example of basic operations.

FIG. 8 is a schematic diagram for explaining another example of the basic operations.

FIG. 9 is a schematic diagram for explaining one example of sharing operations.

FIG. 10 is a flowchart for explaining one example of the basic operations and the sharing operations.

FIG. 11 is a schematic diagram for explaining one registration operations among notification operations.

### DESCRIPTION OF EMBODIMENTS

### Embodiments

### (Configuration of Information Processing System)

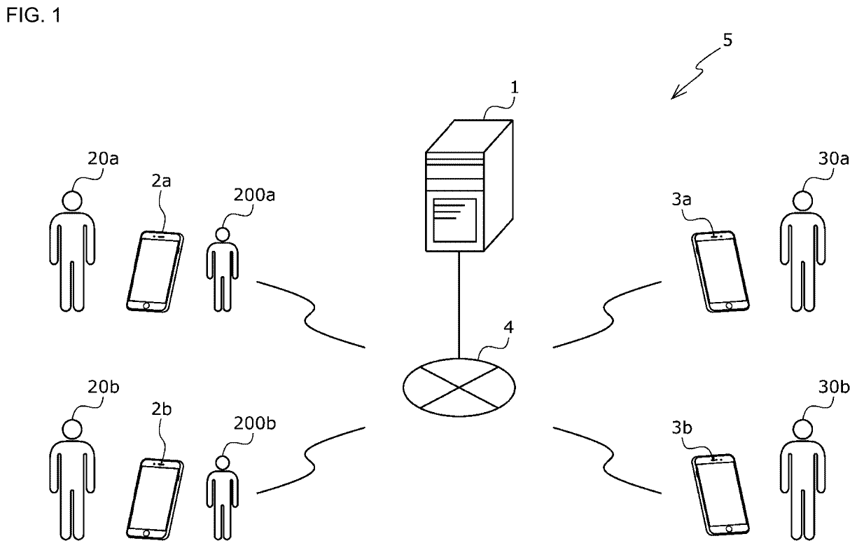

FIG. 1 is a schematic diagram illustrating an example of a configuration of an information processing system according to an embodiment.

An information processing system 5 is configured by connecting an information processing apparatus 1, terminals 2a, 2b . . . and terminals 3a, 3b . . . via a network 4 in a manner that they can communicate with each other. The terminals 2a, 2b . . . are operated by users 20a, 20b . . . and the terminals 3a, 3b . . . are operated by users 30a, 30b . . .

The information processing apparatus 1 is a server-type information processing apparatus that operates in response to requests from the terminals 2a, 2b . . . or the terminals 3a, 3b . . . and includes electronic components such as CPUs (Central Processing Units) having functions for processing information and flash memories in the main body.

The terminals 2a, 2b . . . and the terminals 3a, 3b . . . are information processing apparatuses such as smartphones and tablet PCs (Personal Computers) and include electronic components such as CPUs having functions for processing information and flash memories in the main body. It is assumed that each of the terminals 2a, 2b . . . includes at least a camera and that a program for generating virtual object information based on information captured by the camera is installed and executable in the terminals 2a, 2b . . . In addition, the terminals 3a, 3b . . . need a camera when displaying a virtual object together with an image captured by the camera (Augmented Reality), but the terminals 3a, 3b . . . do not necessarily need to include a camera when simply reproducing the virtual object. In addition, the program for generating the virtual object information may not be installed in the terminals 3a, 3b . . . Here, the virtual object is an object of 3D, and for example, in the case of AR-reproduction, the display position and angle change depending on the orientation of the terminals 2a, 2b . . . and the terminals 3a, 3b . . ., but the virtual object may be of 2D, 4D or more, or the object may be accompanied by a time change.

The network 4 is a communication network capable of high-speed communication and is, for example, a wired or wireless communication network such as an intranet or a LAN (Local Area Network).

In the above configuration, for example, the users 20a, 20b . . . operate the terminals 2a, 2b . . . to image persons 200a, 200b . . ., respectively. The terminals 2a, 2b . . . generate information on virtual objects of the persons 200a, 200b . . . (hereinafter referred to as “virtual object information”) based on the imaging result. The persons 200a, 200b . . . are, for example, children who are growing, and are periodically imaged to generate virtual object information to take growth records. The virtual objects can be reproduced on the terminals 2a, 2b . . .

Thereafter, the users 20a, 20b . . . operate the terminals 2a, 2b . . . to share the virtual object information with the terminals 3a, 3b . . . operated by the users 30a, and the terminals 2a, 2b . . . transmit requests to the information processing apparatus 1 in accordance with the operation contents. The information processing apparatus 1 generates a web page capable of reproducing virtual objects in response to the received requests, and shares a URL (Uniform Resource Locator) for accessing the web page with the terminals 3a, 3b . . . The terminals 3a, 3b . . . access the web page and reproduce the virtual objects. The users 30a, are, for example, relatives such as grandparents, uncle and aunt of the persons 200a, 200b . . . or friends, acquaintances, etc. of the users 30a, 30b . . ., who check the growth records of the persons 200a, 200b . . . through the virtual objects reproduced on the terminals 3a, 3b . . .

### (Configuration of Information Processing Apparatus)

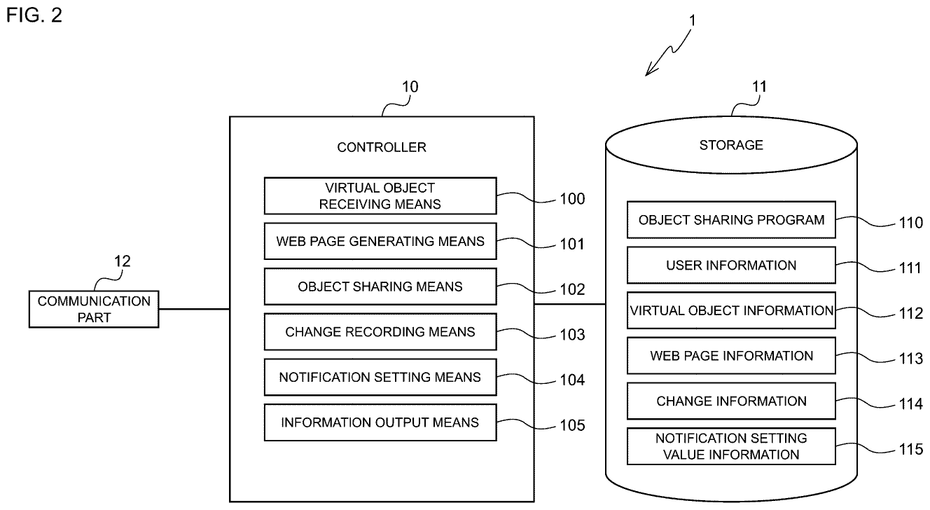

FIG. 2 is a block diagram illustrating a configuration example of the information processing apparatus 1 according to the embodiment.

The information processing apparatus 1 includes a controller 10 that is configured of a CPU and the like, executes various programs and controls each part, a storage 11 that is configured of a storage medium such as a flash memory and stores information, and a communication part 12 that communicates with the outside via the network.

The controller 10 functions as a virtual object receiving means 100, a web page generating means 101, an object sharing means 102, a change recording means 103, a notification setting means 104, an information output means 105, and the like by executing an object sharing program 110 to be described later.

The virtual object receiving means 100 receives virtual object information from the terminals 2a, 2b . . . via the communication part 12 and stores the received virtual object information as virtual object information 112 in the storage 11. The virtual object information 112 may further include information such as a name and age of a subject of the virtual object and a generation date and time of the virtual object as accompanying information of the virtual object.

The web page generating means 101 generates a web page capable of reproducing the virtual object based on the virtual object information 112, and stores the web page as web page information 113 in the storage 11.

The object sharing means 102 shares the object by transmitting the URL of the web page information 113 to the sharing destination in response to a request which is from the sharing source.

The change recording means 103 extracts information such as sizes (body height, leg size, chest circumference, abdomen circumference, waist circumference, head dimensions, hair length, height, depth, width, and the like), weight, and age from the virtual object of the virtual object information 112, or receives input of these pieces of information from the user who has operated a generation of the virtual object information 112, and stores these pieces of information as a change information 114 in the storage 11. The extraction may be a value estimated from the virtual object or a value actually measured by another apparatus.

The notification setting means 104 receives a setting value for notifying the change information 114 and a condition for the setting value, and stores the setting value and the condition in the storage 11 as a notification setting value information 115.

The information output means 105 outputs information such as information for displaying an operation screen, a URL of a web page, or a notification to the terminals 2a, 2b . . . and the terminals 3a, 3b . . .

The storage 11 stores the object sharing program 110 as an information sharing program that causes the controller 10 to operate as the above-described means 100 to 105, a user information 111, the virtual object information 112, the web page information 113, the change information 114, the notification setting value information 115, and the like.

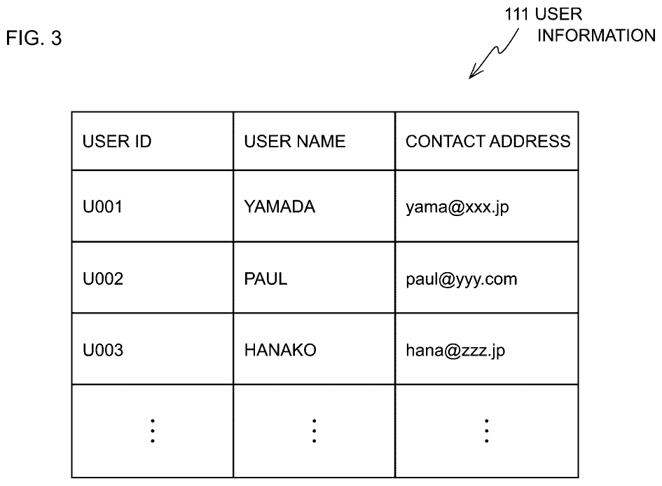

FIG. 3 is a schematic diagram illustrating a configuration example of the user information 111.

The user information 111 includes a user ID for identifying a user, a user name which is a name or title of the user, and a contact address such as a mail address, a telephone number, and a specific service ID of the user. The user information 111 may further include additional items as necessary.

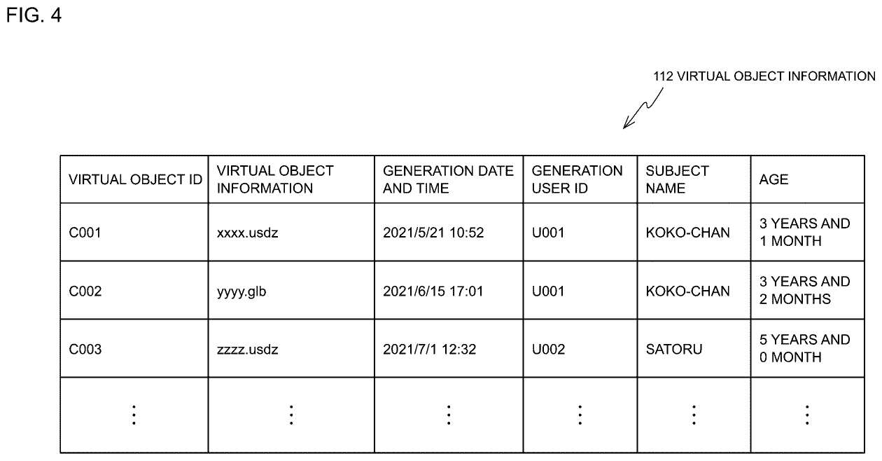

FIG. 4 is a schematic diagram illustrating a configuration example of the virtual object information 112.

The virtual object information 112 includes a virtual object ID for identifying a virtual object, virtual object information which is real data of the virtual object, the generation date and time which is a date and time when the virtual object is generated, a generation user ID which is an ID of a user who generates the virtual object, a subject name which is a name or title of a subject of the virtual object, and an age of the subject. The subject name may be an abbreviation, an endearing name, a nickname, or the like. The age may be calculated from the date of birth and the date of measurement. When the subject is a physical object, the age may be an age of a person who produced the physical object or may be replaced with the elapsed time since the manufacture or creation of the physical object. The virtual object information 112 may further include a country of use, gender, race, and the like (used for estimation of growth to be described later.).

As an example, the virtual object information may use data formats such as a combination of Universal Scene Description authored for AR, point cloud data of formats such as GL Transmission Format, Polygon File Format or Stanford Triangle Format, Point Cloud Data file format, Colored/Colorized Point Data, LIDAR Data Exchange Format, Lizard Safeguard Secure PDF Format, ASCII point cloud file, and Point Cloud Library format, 3DCG data of formats such as 3D Wavefront, COLLADA Format, Autodesk FBX Format, Alembic Format, and 3D Systems STL Format, and depth map data showing two-dimensional images and depth information of formats such as High Efficiency Image File Format, Graphics Interchange Format, Tagged Image File Format, and Portable Network Graphics, and other formats may be used as long as they can be used for AR applications. In addition, the virtual object information may be stationary, may be accompanied by movement according to a data format including time-series information, or may be information in which reproduction content is interactively changed by an operation on the reproduction side.

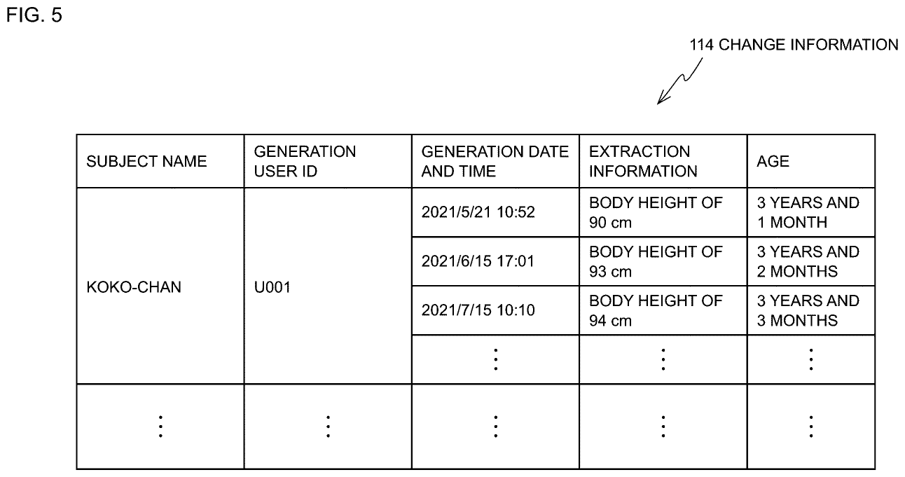

FIG. 5 is a schematic diagram illustrating a configuration example of the change information 114.

The change information 114 includes the subject name, the generation user ID, the generation date and time, an extraction information which is information extracted from the virtual object information by the change recording means 103, and the age. The extraction information may be information that has been input.

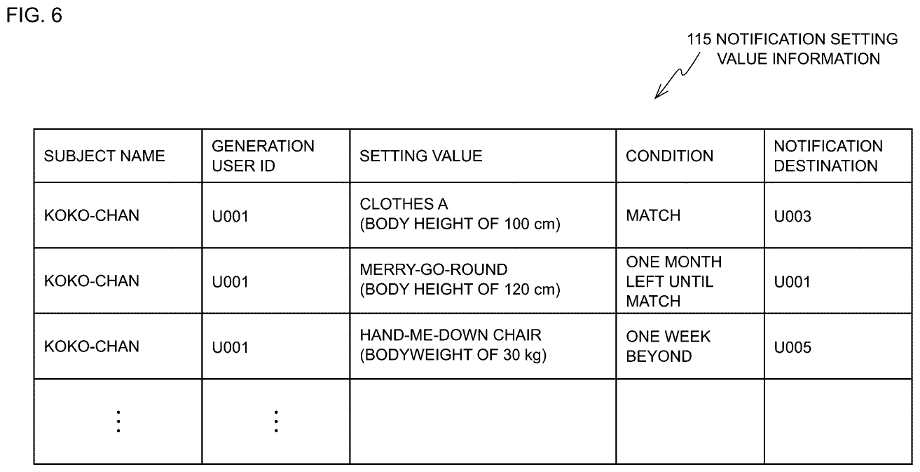

FIG. 6 is a schematic diagram illustrating a configuration example of the notification setting value information 115.

The notification setting value information 115 includes the subject name, the generation user ID, a setting value that is a value serving as a trigger for executing a notification, a condition for executing the notification with respect to the setting value, and a notification destination.

### (Operation of Information Processing Apparatus)

Next, the action of the present embodiment will be described in terms of (1) basic operations, (2) sharing operations, and (3) notification operations. (1) Basic operations: first, in order to use a service provided by the information processing system 5, the users 20a, 20b . . . and 30a, 30b . . . operate the terminals 2a, 2b . . . and 3a, 3b . . . respectively to register the user information. The terminals 2a, 2b . . . and 3a, 3b . . . transmit registration requests to the information processing apparatus 1 together with the user information in accordance with the operation contents.

The information processing apparatus 1 receives the user information together with the registration requests, and stores the user information in the storage 11 as the user information 111 as illustrated in FIG. 3.

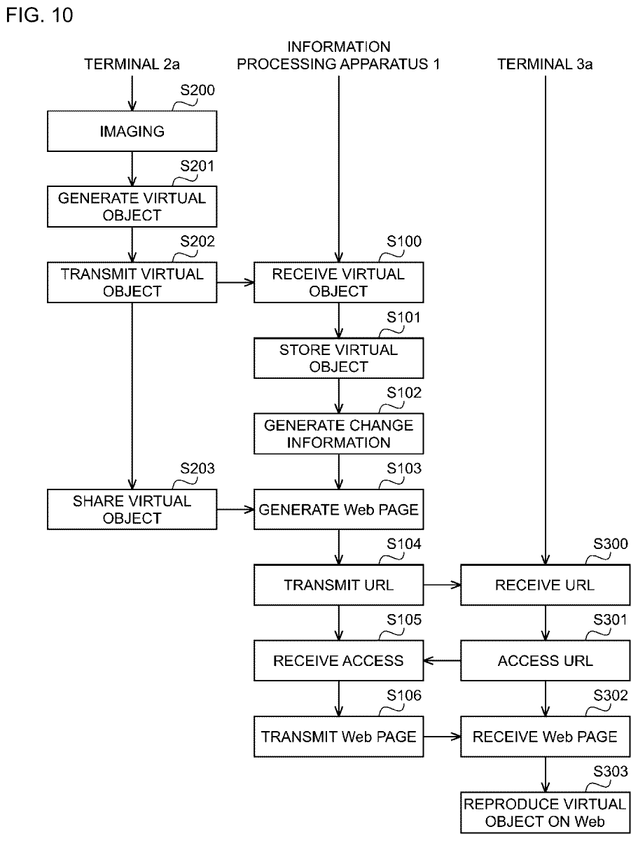

FIG. 10 is a flowchart for explaining one example of the basic operations and the sharing operations.

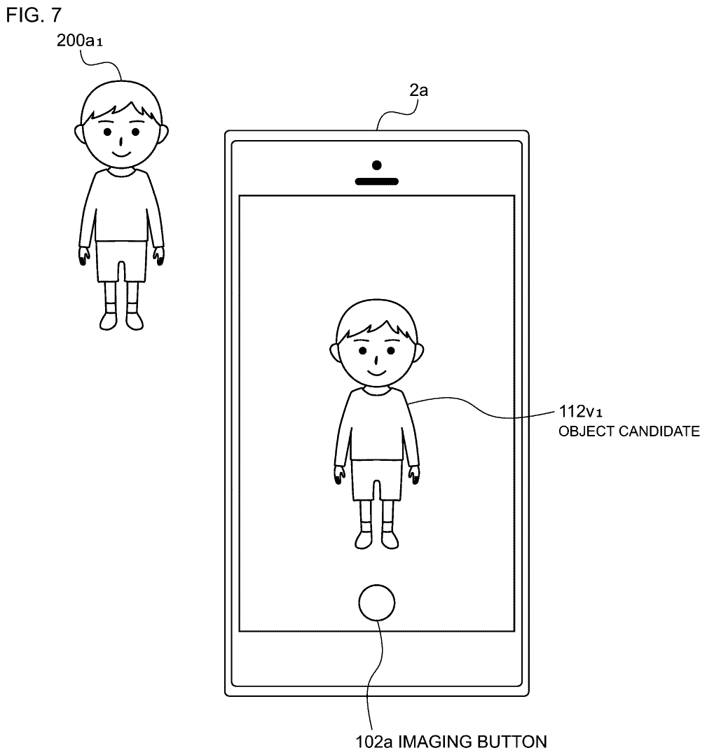

Next, as illustrated in FIG. 7, the users 20a, 20b . . . operate the terminals 2a, 2b . . . to image the persons 200a, 200b . . . (S200) and generate the virtual object information in the terminals 2a, 2b . . . (S201). The virtual object information may be generated from information of images taken in the past and information such as height (which may be set by input or may be estimated from the subject in an image) and age (which may be set by input or may be calculated from the imaging date and time and the birth date). Hereinafter, the operation of the terminal 2a will be described in order to simplify the description, and it is assumed that the terminal 2b operates in the same manner when the terminal 2a is replaced by the terminal 2b.

FIG. 7 is a schematic diagram for explaining one example of basic operations.

The terminal 2a displays an imaging preview screen on a display, and when imaging a person 200a₁, an object candidate 112v₁ is displayed on the screen. The user 20a operates an imaging button 102a on the screen to image the object candidate 112v₁.

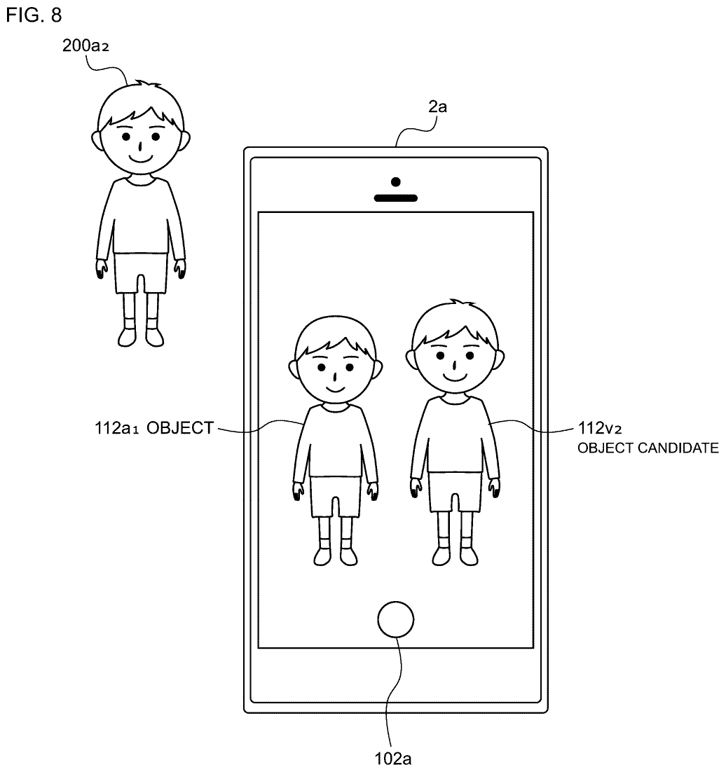

After the virtual object information is generated in FIG. 7 described above, as illustrated in FIG. 8, the user 20a operates the terminal 2a to image the person 200a who has grown as the subject (S200) to generate virtual object information in the terminal 2a (S201). The subject is not limited to the person 200a, and may be a building block, a sand castle, clay, or the like made by the person 200a, or may be an animal, the abdominal region of a pregnant woman, or the like. The subject may also be clothing, tableware, furnishings, food and drink, furnishings, small items, etc., related or unrelated to the person 200a.

FIG. 8 is a schematic diagram for explaining another example of the basic operations.

The terminal 2a displays the imaging preview screen on the display, and when the terminal 2a images the person 200a₂ who is the grown-up person 200a₁, the object 112a₁ generated by the imaging in FIG. 7 and the object candidate 112v₂ which is the current subject are displayed on the screen. The user 20a images the object candidate 112v₂ by operating the imaging button 102a on the screen while adjusting the arrangement of the object 112a₁. The above-described imaging preview screen may be an AR display screen that is not accompanied by imaging.

Further, the user 20a appropriately registers information such as the name, age, and generation date and time of the person 200a as accompanying information of the generated virtual object information. The terminal 2a stores the generated virtual object information in a storage in the terminal 2a and transmits the virtual object information to the information processing apparatus 1 (S202). The transmission timing may be a timing at which the virtual object information is generated, a timing at which step S203 to be described below is performed, or a timing between these timings.

The virtual object receiving means 100 of the information processing apparatus 1 receives the virtual object information from the terminal 2a via the communication part 12 (S100), and stores the received virtual object information in the storage 11 as the virtual object information 112 (S101).

In addition, the change recording means 103 extracts sizes (body height, leg size, chest circumference, abdomen circumference, waist circumference, head dimensions, hair length, height, depth, width, and the like), weight, age, and the like from the virtual object of the virtual object information 112, generates the change information 114, and stores the change information 114 in the storage 11 (S102).

The change information 114 may be provided to the terminals 2a, 2b . . ., 3a, 3b . . . as information itself, or may be provided as information processed into a graph or chart. Further, the change information 114 may be provided to an external shopping site or the like.

### (2) Sharing Operations

Next, for example, when the user 20a desires to share the generated virtual object with the user 30a, the user 20a designates a contact address of the terminal 3a and operates the terminal 2a to request the information processing apparatus 1 to share the virtual object. The terminal 2a requests the information processing apparatus 1 to share the virtual object (S203).

When the web page generating means 101 of the information processing apparatus 1 receives the virtual object sharing request together with the contact address of the terminal 3a, the web page generating means 101 generates a web page capable of reproducing the virtual object based on the virtual object information 112 (S103), and stores the web page in the storage 11 as the web page information 113. A single virtual object or a plurality of virtual objects may be reproduced on the web page. In the case of a plurality of virtual objects, basically, virtual objects of the same subject of the same generation user ID are arranged in the order of generation date and time, etc. to generate a web page, but the embodiment is not limited thereto, and virtual objects of different generation user IDs and different subjects may be arranged. In addition, the web page generating means 101 may include a plurality of data formats of the virtual object information included in the web page information 113 in accordance with an OS (Operating System) or the like of a terminal that reproduces the web page information 113. For example, when the virtual object information generated in the terminal 2a is usdz, the usdz is converted to generate glb, and the glb is included in the web page information 113. When the web page information 113 is transmitted to the terminal 3a, both usdz and glb may be included and transmitted, or the OS of the terminal 3a which is the transmission destination may be determined and only one of usdz and glb may be transmitted. Further, the plurality of data formats may be generated in an imaging terminal.

The above-described web page information 113 enables the virtual object information 112 to be reproduced on a web page with a method of displaying AR information using 3DCG data on a website such as a WebAR website.

Next, in response to a request from the sharing source, the object sharing means 102 shares the object by transmitting the URL of the web page information 113 as access information to a contact address (such as an e-mail address of the terminal 3a) of the sharing destination (S104). The sharing may be performed each time in response to a request from the sharing source, or may be automatically performed based on comprehensive sharing settings set in advance by the sharing source. Alternatively, when there is a URL that has been shared in advance, the object displayed on the web page corresponding to the URL may be updated by the sharing source afterward.

The terminal 3a receives the URL together with the message indicating that the virtual object has been shared from the information processing apparatus 1 (S300), and displays the message and the URL on the display. When the user 30a checks the message and the URL and checks the shared virtual object, the user 30a operates the terminal 3a.

The terminal 3a accesses the shared URL in response to the operation of the user 30a (S301).

The information output means 105 of the information processing apparatus 1 receives the access (S105) and transmits the web page information 113 corresponding to the URL to the terminal 3a (S106).

The terminal 3a receives the web page information 113 from the information processing apparatus 1 (S302), displays the web page by a web browser or the like, and reproduces the virtual object on the web page (S303). The virtual objects reproduced on the web page are described as one example in which the virtual objects of the same subject of the same generation user ID are arranged in the order of the generation date and time, etc., but the embodiment is not limited thereto, and a single virtual object may be displayed.

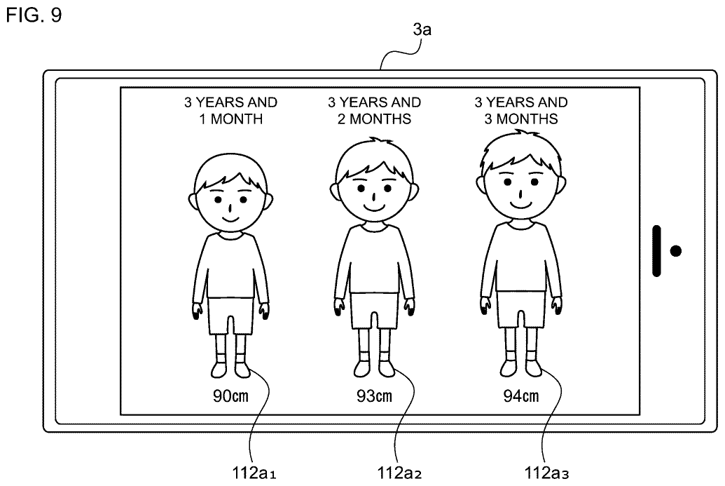

FIG. 9 is a schematic diagram for explaining one example of sharing operations.

The terminal 3a displays the screen for reproducing the virtual object on the display, and the virtual object 200v₁ and the virtual objects 200v₂, 200v₃ . . . in which the same person of the virtual object 200v₁ has grown up are arranged and displayed in a time series. In addition, accompanying information such as age and body height is displayed together with the virtual objects 200v₁, 200v₂, 200v₃ . . . The accompanying information may also be displayed on the screen in FIG. 8.

The user 30a checks the virtual objects 200v₁, 200v₂, 200v₃ . . . displayed on the display of the terminal 3a while changing the arrangement, the viewpoint, and the like by operating the terminal 3a. In addition to the virtual objects 200v₁, 200v₂, 200v₃ . . . displayed on the terminal 3a, new virtual objects may be generated when the terminal 3a includes a camera and has the function of displaying or imaging other subjects to generate virtual objects. (3) Notification Operations

Next, when the users 20a, 20b . . . and 30a, 30b . . . want to receive notifications in accordance with the growth of the persons 200a, 200b . . ., the users first make settings for notifications as described below. The content of notification may be, for example, that the clothing sizes match, or that one month is left until the conditions for participating in an amusement park attraction are satisfied. An example in which the user 30a receives a notification will be described below, and the same applies to a case in which another user receives a notification.

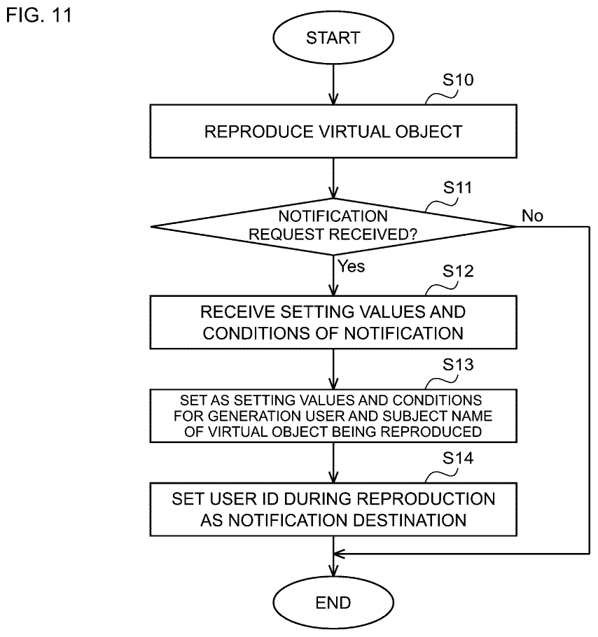

FIG. 11 is a schematic diagram for explaining one example of notification setting value information registration operations among notification operations.

For example, the user 30a reproduces the virtual object on the web page as described in FIG. 9 (S10). When the virtual object information is stored not on the web page but in the terminal 3a, the virtual object may be reproduced based on the virtual object information. The subject may be designated according to a virtual object ID, a subject name, a generation user ID, or the like without reproducing the virtual object.

When the user 30a desires a notification setting for the virtual object being reproduced, the user 30a operates the terminal 3a to request the notification setting. As the content of notification, for example, a notification is set to be performed when the body height reaches an extent at which the clothes A (body height is “100 cm”) can be worn (when the body height “matches”).

The notification setting means 104 of the information processing apparatus 1 receives the notification request from the terminal 3a (S11), receives the setting values and conditions of the notification (S12), and sets the received setting values and conditions as the notification setting value information 115 including the setting values and conditions for the generation user and the subject name of the virtual object being reproduced (S13). Here, as illustrated in FIG. 6, with respect to the subject name “Coco-chap” and the generation user ID “U001”, “clothes A (body height of 100 cm)” and the condition “match” are set as the setting values, and the notification destination “U003” which is the user ID during reproduction is set as the notification destination (S14).

Next, the information output means 105 monitors the change information 114, and when the setting values and the conditions of the notification setting value information 115 are satisfied, a notification is made to the terminal 3a which is set as the notification destination. When “merry-go-round (body height of 120 cm)” and the condition “one month left until match” are set as the setting values, the information output means 105 calculates the growth rate from the change information 114, and notifies the terminals set as the notification destinations at the time point when it is predicted that one month is left until match.

“Clothes A (body height of 100 cm)” as the above-described setting value may be, for example, clothes being sold on a shopping site, and when the shopping site receives a notification from the information processing apparatus 1, the clothes may be sent to a designated sending destination. Further, the notification setting does not necessarily have to be made by the user, and a notification setting prepared in advance may be selected. In addition, the subject name and the generation user ID may not necessarily be set in the notification setting value information 115, and for example, a user who wants to give away unwanted clothes may designate only setting values and conditions and notify another user who matches the setting values of the conditions of the intention of giving away the clothes. In addition, for example, in a case where the clothes transferred do not match the sizes of the persons 200a, 200b at the time point when the clothes are transferred, the users 20a, 20b may make a notification at the time point when the persons 200a, 200b grow to have the sizes.

### Effects of Embodiment

According to the above-described embodiment, the virtual object information generated in the terminals 2a, 2b . . . is stored in the storage 11 of the information processing apparatus 1, the web page information capable of reproducing the virtual object information is generated in the information processing apparatus 1, and the URL for accessing the web page information is transmitted to the terminals 3a, 3b . . . to share the virtual object, and thus, when sharing the virtual object, it is not necessary to directly transmit real information of the virtual object between the terminals 2a, 2b . . . and the terminals 3a, 3b . . . and the preparatory processes for reproducing virtual data such as the programs and applications in the terminals 3a, 3b . . . which are reproduction terminals are reduced.

In addition, the change information 114 is recorded in the information processing apparatus 1 and a notification destination is notified when the change information 114 satisfies the setting values and the conditions based on the notification setting value information 115 which has been set, and thus, the users 30a, 30b who are notification destinations can know appropriate clothes, playground equipment, or the like in accordance with the growth of the persons 200a, 200b.

A plurality of data formats of the virtual object information included in the web page information 113 are included in accordance with the specifications of the terminals that reproduce the web page information 113, and thus, it is not necessary to perform format conversion of the virtual object information in any of the terminals 2a, 2b that generate information and the terminals 3a, 3b that reproduce information, the functions of the programs and applications in the terminals 2a, 2b which are information generating terminals can be reduced, and the preparatory processes for reproducing virtual data such as the programs and applications in the terminals 3a, 3b . . . which are reproduction terminals are reduced.

### Other Embodiments

The present invention is not limited to the above-described embodiment, and various modifications can be made within the scope of not departing from the gist of the present invention.

In the above-described embodiment, the functions of the means 100 to 105 of the controller 10 are realized by programs, but all or some of the means may be realized by hardware such as an ASIC. The program used in the above-described embodiment may be provided by being stored in a recording medium such as a CD-ROM. In addition, replacement, deletion, addition, and the like of the above-described steps described in the above-described embodiment are possible within the scope of not changing the gist of the present invention. Further, some or all of the functions of the information processing apparatus 1 may be configured to be executable by the terminals 2a, 2b, 3a, 3b, or some or all of the functions of the terminals 2a, 2b, 3a, 3b may be configured to be executable by the information processing apparatus 1.

The above-described embodiment describes the case where the virtual object is reproduced as it is and the case where the virtual object is reproduced by AR, but the virtual object may also be reproduced by XR (X Reality) such as MR (Mixed Reality), VR (Virtual Reality), or SR (Substitutional Reality).

### INDUSTRIAL APPLICABILITY

The embodiments provide an information sharing program and an information processing apparatus in which transmission of real information itself of a virtual object between terminals is not required and preparation for virtual data reproduction in a reproduction terminal is not required when the virtual object is shared.

### Reference Signs List

1 Information processing apparatus
2a, 2b Terminal
3a, 3b Terminal
4 Network
5 Information processing system
10 Controller
11 Storage
12 Communication part
20a, 20b User
30a, 30b User
100 Virtual object receiving means
101 Web page generating means
102 Object sharing means
103 Change recording means
104 Notification setting means
105 Information output means
110 Object sharing program
111 User information
112 Virtual object information
113 Web page information
114 Change information
115 Notification setting value information

The claims:

1. A non-transitory computer-readable medium containing executable instructions which when executed by one or more processors of a computer, causes the computer to perform operation comprising:
receiving and storing one or a plurality of pieces of virtual object information generated in a terminal by imaging a subject;
generating web page information capable of reproducing the one or the plurality of pieces of virtual object information on a web page; and
transmitting access information to the web page information to a sharing destination, upon receiving the terminal's request for sharing and information on the sharing destination.

2. The non-transitory computer-readable medium according to claim 1, wherein the operation of generating includes generating the web page information for reproducing the one or the plurality of pieces of the virtual object information generated by imaging the subject on the web page based on an accompanying information of the virtual object.

3. The non-transitory computer-readable medium according to claim 1, the operation further comprising extracting information related to at least one of a size and a weight of the subject, as a change information, from the plurality of pieces of the virtual object information generated by imaging the subject, and outputting the change information.

4. The non-transitory computer-readable medium according to claim 1, the operation further comprising extracting information related to at least one of a size and a weight, as a change information, from the plurality of pieces of the virtual object information generated by imaging the subject, and outputting a notification when based on the change information, the size matches, exceeds, or falls below a predetermined size or is expected to match, exceed, or fall below the predetermined size.

5. The non-transitory computer-readable medium according to claim 1, wherein the operation of generating includes generating the web page information capable of reproducing an image taken on a terminal and the one or the plurality of pieces of virtual object together on a web page.

6. An information processing apparatus comprising:
one or more processors of a computer;
a non-transitory computer-readable medium containing executable instructions which when executed by the one or more processors of the computer, causes the computer to perform operation comprising:
receiving and storing virtual object information generated in a terminal by imaging a subject;
generating web page information capable of reproducing the virtual object information on a web page; and
transmitting to a sharing destination access information to the web page information, upon receiving the terminal's request for sharing and information about the sharing destination.

7. A computer-implemented method for sharing information comprising:
receiving and storing one or a plurality of pieces of virtual object information generated in a terminal by imaging a subject;
generating web page information capable of reproducing the one or the plurality of pieces of virtual object information on a web page; and
transmitting access information to the web page information to a sharing destination, upon receiving the terminal's request for sharing and information on the sharing destination.

8. The non-transitory computer-readable medium according to claim 2, the operation further comprising extracting information related to at least one of a size and a weight of the subject, as a change information, from the plurality of pieces of the virtual object information generated by imaging the subject, and outputting the change information.

9. The non-transitory computer-readable medium according to claim 2, the operation further comprising extracting information related to at least one of a size and a weight, as a change information, from the plurality of pieces of the virtual object information generated by imaging the subject, and outputting a notification when based on the change information, the size matches, exceeds, or falls below a predetermined size or is expected to match, exceed, or fall below the predetermined size.

10. The non-transitory computer-readable medium according to claim 2, wherein the operation of generating includes generating the web page information capable of reproducing an image taken on a terminal and the one or the plurality of pieces of virtual object together on a web page.

11. The non-transitory computer-readable medium according to claim 3, wherein the operation of generating includes generating the web page information capable of reproducing an image taken on a terminal and the one or the plurality of pieces of virtual object together on a web page.

12. The non-transitory computer-readable medium according to claim 4, wherein the operation of generating includes generating the web page information capable of reproducing an image taken on a terminal and the one or the plurality of pieces of virtual object together on a web page.
